(19) United States
(12) Patent Application Publication
(10) Pub. No.: US 2019/0377922 A1
(43) Pub. Date: Dec. 12, 2019

(54) ENABLING IDENTIFICATION OF FINGERPRINTS FROM CAPTURED IMAGES USING CONTOUR POINTS

(71) Applicant: Fingerprint Cards AB, GÖTEBORG (SE)

(72) Inventor: Mikkel B. STEGMANN, Vanløse (DK)

(73) Assignee: Fingerprint Cards AB, GÖTEBORG (SE)

(21) Appl. No.: 16/485,262

(22) PCT Filed: Feb. 12, 2018
(86) PCT No.: PCT/SE2018/050126

§ 371 Date: Aug. 12, 2019

(30) Foreign Application Priority Data
Feb. 17, 2017 (SE) 1750155-2

(51) Int. Cl. G06K 9/00

(52) U.S. Cl. CPC G06K 9/001; G06K 9/00067

(57) ABSTRACT

The invention relates to a method performed by a fingerprint sensing system of enabling identification of a fingerprint in an image captured by a fingerprint sensor of the fingerprint sensing system, and a fingerprint sensing system performing the method.

### TECHNICAL FIELD

The invention relates to a method performed by a fingerprint sensing system of enabling identification of a fingerprint in an image captured by a fingerprint sensor of the fingerprint sensing system, and a fingerprint sensing system performing the method.

### BACKGROUND

Traditional computer vision approaches to detection of image interest points for recognition purposes do not exhibit the desirable traits of repeatability and sufficient density when subjected to fingerprint images, which are either void of small-scale detail, or have impairments, e.g. due to moist, dry or sweaty skin conditions, or present other factors contributing to pronounced variation in image appearance.

This behaviour is due to detector designs typically targeting corner- or blob structures, which are consistent and typically available in abundance in e.g. natural images of man-made structures, but not in fingerprint images.

Electronic devices such as smart phones, laptops, remote controls, tablets, smart cards, etc., may use fingerprint recognition e.g. to allow a user to access the device, to authorize transactions carried out using the electronic device, or to authorize the user for accessing a service via the electronic device.

Hence, the electronic device, being for example a smart phone, is equipped with a fingerprint sensor on which the user places her finger in order for the sensor to capture an image of the fingerprint and compare the recorded fingerprint with a pre-stored, authenticated fingerprint template. If the recorded fingerprint matches the pre-stored template, the user is authenticated and the smart phone will perform an appropriate action, such as transitioning from locked mode to unlocked mode, in which the user is allowed access to the smart phone.

Touch fingerprint images are commonly either void of small-scale features such as ridge contour detail, or have unstable small-scale detail, and hence fail to produce a sufficient density of interest points that are stable between different acquisitions of a part of a finger, when employing traditional corner-oriented methods. This is in particular prevalent for moist, sweaty and dry skin conditions, and may lead to a decreased biometric performance since it becomes difficult to extract a detailed fingerprint from the captured image.

### SUMMARY

An object of the present invention is to solve, or at least mitigate, this problem in the art and thus to provide an improved method of enabling identification of a fingerprint in a captured image.

This object is attained in a first aspect of the invention by a method performed by a fingerprint sensing system of enabling identification of a fingerprint in an image captured by a fingerprint sensor of the fingerprint sensing system. The method comprises capturing at least one image of a fingerprint of a finger contacting the fingerprint sensor, detecting contour points of at least one ridge or valley of the fingerprint of the captured image, projecting the contour points onto the medial axis of said at least one ridge or valley, thereby enabling forming said at least one ridge or valley from the contour points projected onto the medial axis to enable identification of a fingerprint.

This object is attained in a second aspect of the invention by a fingerprint sensing system comprising a fingerprint sensor and a processing unit, the fingerprint sensing system being configured to enable identification of a fingerprint in an image captured by the fingerprint sensor. The fingerprint sensor is configured to capture at least one image of a fingerprint of a finger contacting the fingerprint sensor. The processing unit is configured to detect contour points of at least one ridge or valley of the fingerprint of the captured image, and project the contour points onto the medial axis of said at least one ridge or valley, thereby enabling forming said at least one ridge or valley from the contour points projected onto the medial axis to enable identification of a fingerprint.

Hence, by projecting the contour points onto the medial axis of the respective ridge and/or valley of a fingerprint in the captured image, interest points derived from contour points are fixated, in lack of stable corners, in one dimension by way of the medial axes of fingerprint valleys or ridges, i.e. a set of points having more than one nearest valley/ridge contour point.

With the projection of the contour points onto the medial axes of the fingerprint valleys/ridges in the captured image, more stable candidate interest points situated on the respective medial axis are created, and a fingerprint sensing system less susceptible to noise is advantageously attained.

Thus, a far more robust method of locating valleys and/or ridges in fingerprint images is advantageously provided as compared to the prior art approach of using conventional interest point detection to extract valleys/ridges.

This is particularly relevant in case a relatively sparse set of contour points are used to form valleys/ridges. In practice, a fingerprint sensing system operates with a limited number of resulting candidate interest points due to processing capability of the processing unit of the system, and requirements on fingerprint processing time.

It is noted that the invention describes a subpart of an entire fingerprint sensing system related to describing a fingerprint image in terms of interest points, from which identification of a fingerprint is enabled. Subsequently, candidate interest points are processed and fingerprint ridges and valleys are formed in order to identify the fingerprint.

As previously discussed, in fingerprint images, it is oftentimes not possible to reliably detect corners due to a lack of detectable, or stable, features in the images. However, in an embodiment, in situations when corners indeed can be detected, the processing unit detects interest points in the captured image using corner-based detection and subsequently projects these corner points onto the medial axis, yielding a hybrid where the resulting medial axis points originate from a mixture of contour points and corner points.

In a further embodiment, when detecting the contour points the processing unit performs edge detection on the captured image and randomly samples a subset of the edge-detected points to derive the contour points.

Advantageously, in an embodiment, a combination of edge-detected contour points and corner-detected points is utilized, thereby exploiting small-scale features when available, while turning to stable medium-scale features, i.e. valleys or ridges, in the absence of small-scale features.

In a further embodiment, a projected contour or corner point is accepted in a set of projected contour or corner points characterising a ridge and/or valley only if the projected contour or corner point is located on a distance greater than a selected minimum distance from a previously accepted projected contour or corner point along the medial axis.

In practice, most fingerprint sensing systems work with a point budget which limits the number of resulting candidate interest points that can be derived for reasons of computing capability and/or a maximum allowed processing time. Advantageously, with a proximity criterion stipulating that a projected contour or corner point must be located on a distance greater than a selected minimum distance from a previously accepted projected contour or corner point along the medial axis in order to be accepted, a degree of density control is attained.

Further embodiments of the invention will be described in the detailed description.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 shows an electronic device in the form of a smart phone in which the present invention may be implemented;

FIG. 2 shows a view of a fingerprint sensor onto which a user places her finger;

FIG. 3 shows a fingerprint sensor being part of a fingerprint sensing system according to an embodiment;

FIG. 4 illustrates a flowchart of the method of enabling identification of a fingerprint in a captured image according to an embodiment of the present invention using contour points;

FIG. 5a illustrates an image of a fingerprint captured by the fingerprint sensing system of the invention;

FIG. 5b illustrates a sub-section of the image of FIG. 5a, where contour points and a corner point are projected onto a medial axis of a fingerprint valley according to an embodiment;

FIG. 5c illustrates a flowchart of the method of enabling identification of a fingerprint in a captured image according to an embodiment of the present invention using contour points as well as a corner point;

FIG. 6a illustrates another image of a fingerprint captured by the fingerprint sensing system of the invention;

FIG. 6b illustrates a sub-section of the image of FIG. 6a, where a contour point is projected onto a medial axis of a fingerprint valley;

FIG. 7 illustrates the sub-section of the fingerprint as shown in FIG. 5b, but where contours of the fingerprint valley are less affected by noise;

FIG. 8 illustrates the sub-section of the fingerprint as shown in FIG. 5b, further depicting a proximity criterion to be fulfilled according to an embodiment;

FIG. 9a illustrates the deriving of interest points from which a fingerprint in a captured image can be identified using conventional interest point detection; and

FIG. 9b illustrates the deriving of interest points from which a fingerprint in a captured image can be identified using medial axis projection according to the invention.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

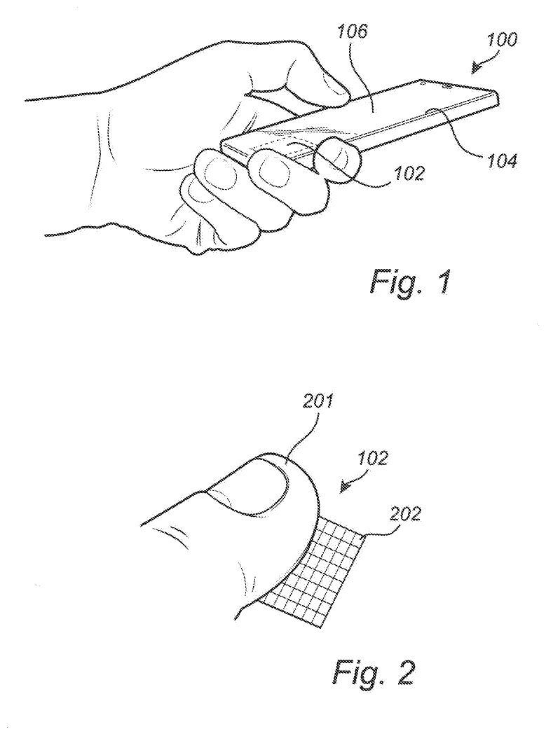

FIG. 1 shows an electronic device in the form of a smart phone 100 in which the present invention may be implemented. The smart phone 100 is equipped with a fingerprint sensor 102 and a display unit 104 with a touch screen interface 106. The fingerprint sensor 102 may, for example, be used for unlocking the mobile phone 100 and/or for authorizing transactions carried out using the mobile phone 100, etc. The fingerprint sensor 102 may alternatively be placed on the backside of the mobile phone 100. It is noted that the fingerprint sensor 102 could be integrated in the display unit/touch screen or form part of a smart phone home button.

It is understood that the fingerprint sensor 102 according to embodiments of the invention may be implemented in other types of electronic devices, such as laptops, remote controls, tablets, smart cards, etc., or any other type of present or future similarly configured device utilizing fingerprint sensing.

FIG. 2 illustrates a somewhat enlarged view of the fingerprint sensor 102 onto which a user places her finger 201. In the case of employing a capacitive sensing technology, the fingerprint sensor 102 is configured to comprise a plurality of sensing elements. A single sensing element (also denoted as a pixel) is in FIG. 2 indicated by reference numeral 202.

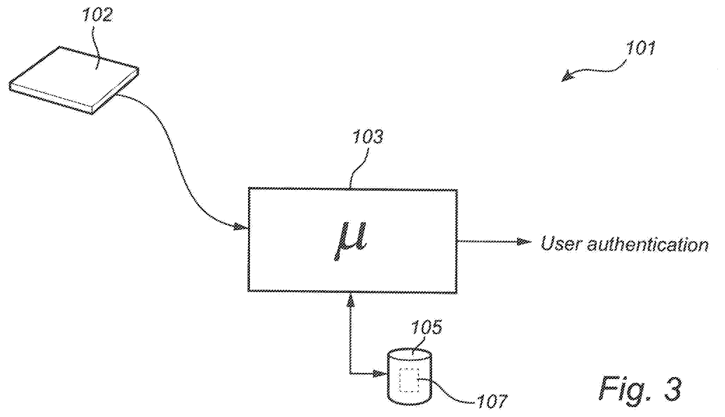

FIG. 3 shows the fingerprint sensor 102 being part of a fingerprint sensing system 101. The fingerprint sensing system 101 comprises the fingerprint sensor 102 and a processing unit 103, such as a microprocessor, for controlling the fingerprint sensor 102 and for analysing captured fingerprints. The fingerprint sensing system 101 further comprises a memory 105. The fingerprint sensing system 101 in turn, typically, forms part of the electronic device 100 as exemplified in FIG. 1.

Now, upon an object contacting the fingerprint sensor 102, the sensor 102 will capture an image of the object in order to have the processing unit 103 determine whether the object is a fingerprint of an authorised user or not by comparing the captured fingerprint to one or more authorised fingerprint templates pre-stored in the memory 105.

The fingerprint sensor 102 may be implemented using any kind of current or future fingerprint sensing principle, including for example capacitive, optical, ultrasonic or thermal sensing technology. Currently, capacitive sensing is most commonly used, in particular in applications where size and power consumption are important. Capacitive fingerprint sensors provide an indicative measure of the capacitance between (see FIG. 2) several sensing elements 202 and a finger 201 placed on the surface of the fingerprint sensor 102. Acquisition of a fingerprint image is typically performed using a fingerprint sensor 102 comprising a plurality of sensing elements 202 arranged in a two-dimensional manner.

In a general authorization process, the user places her finger 201 on the sensor 102 for the sensor to capture an image of the fingerprint of the user. The processing unit 103 evaluates the captured fingerprint and compares it to one or more authenticated fingerprint templates stored in the memory 105. If the recorded fingerprint matches the pre-stored template, the user is authenticated and the processing unit 103 will typically instruct the smart phone 100 to perform an appropriate action, such as transitioning from locked mode to unlocked mode, in which the user is allowed access to the smart phone 100.

With reference again to FIG. 3, the steps of the method performed by the fingerprint sensing system 101 (apart from capturing the image, which is carried out by the sensor 102) are in practice performed by the processing unit 103 embodied in the form of one or more microprocessors arranged to execute a computer program 107 downloaded to the storage medium 105 associated with the microprocessor, such as a Random Access Memory (RAM), a Flash memory or a hard disk drive. The processing unit 103 is arranged to cause the fingerprint sensing system 101 to carry out the method according to embodiments when the appropriate computer program 107 comprising computer-executable instructions is downloaded to the storage medium 105 and executed by the processing unit 103. The storage medium 105 may also be a computer program product comprising the computer program 107. Alternatively, the computer program 107 may be transferred to the storage medium 105 by means of a suitable computer program product, such as a Digital Versatile Disc (DVD) or a memory stick. As a further alternative, the computer program 107 may be downloaded to the storage medium 105 over a network. The processing unit 103 may alternatively be embodied in the form of a digital signal processor (DSP), an application specific integrated circuit (ASIC), a field-programmable gate array (FPGA), a complex programmable logic device (CPLD), etc. It should further be understood that all or some parts of the functionality provided by means of the processing unit 103 may be at least partly integrated with the fingerprint sensor 102.

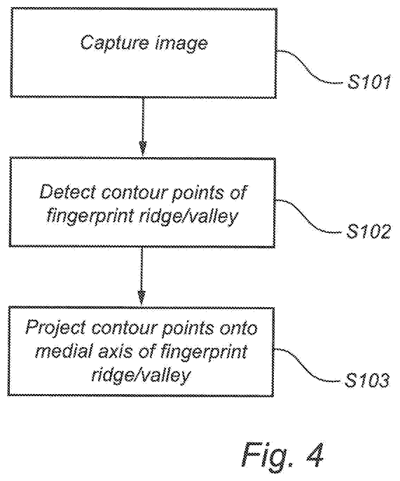

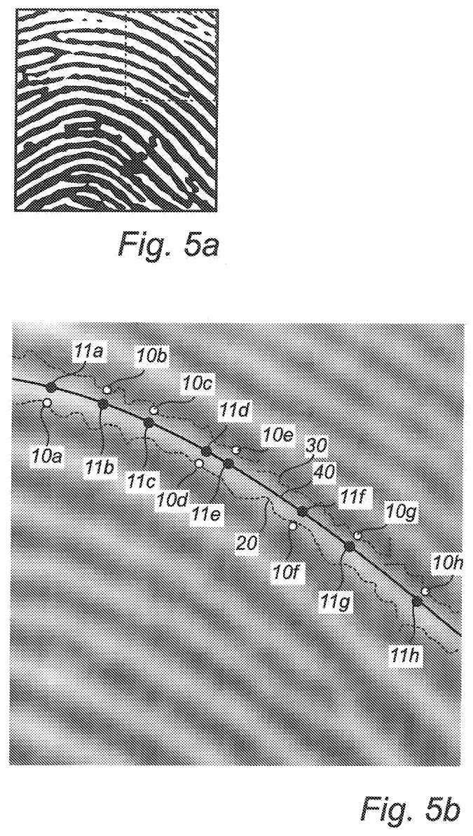

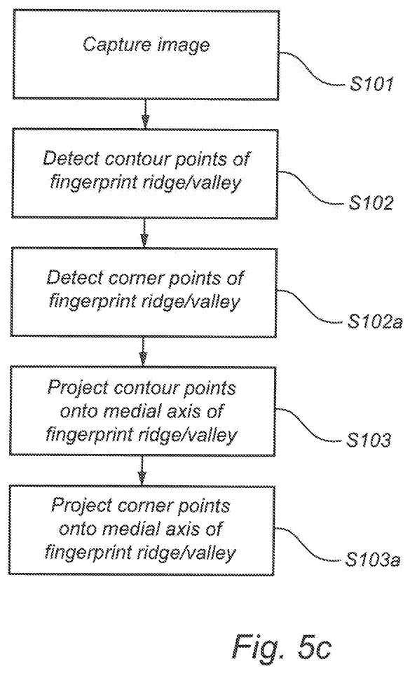

An embodiment of the method of enabling identification of a fingerprint in a captured image will now be described with reference to the flowchart of FIG. 4, to the illustration of a captured image of a fingerprint of FIG. 5a and to a sub-section of the captured image in FIG. 5b as indicated by the dashed box in FIG. 5a.

Hence, in a first step S101, the fingerprint sensor 102 captures at least one image of a fingerprint of a finger contacting the fingerprint sensor 102, i.e. the image shown in FIG. 5a.

Thereafter, in step S102, the processing unit 103 detects contour points of at least one ridge or valley of the fingerprint in the captured image. In practice, contour points are simultaneously detected in the entire image for a great number of ridges and/or valleys. For brevity, detection of contour points of a single valley is illustrated in the following to describe a basic principle of the invention.

In FIGS. 5a and b, white curvatures indicate valleys of the fingerprint, while black curvatures indicate ridges. The processing unit 103 may detect contour points of either ridges or valleys of the fingerprint, or both ridges and valleys.

In an embodiment, the processing unit 103 implements conventional corner-based interest point detection for detecting corner points in the captured image. However, as previously discussed, in fingerprint images, it is oftentimes not possible to reliably detect corners due to a lack of detectable, or stable, features in the images. Nevertheless, interest points may be detected in a captured image using conventional corner-based interest point detection when possible, which may result in a set of salient corner points (i.e. when small-scale detail of a sufficient strength is available).

In another embodiment, the processing unit 103 detects interest points in a captured image using edge detection and then randomly samples the contour points from these edge-detected interest points, thereby resulting in random samples of non-salient contour points.

In FIG. 5b, a combination of randomly sampled edge-detected contour points and corner-detected interest points (forming the corner points) is utilized.

In FIG. 5b, showing a sub-section of the captured image of FIG. 5a, point-based characterization of a valley is performed by the fingerprint sensing system using eight points (N=8); seven contour points and one corner point.

Starting from the left-hand side of FIG. 5b, five randomly sampled contour points 10a-10e are shown. A sixth point, 10f, is a corner point in this particular exemplifying embodiment detected in the captured image by means of the processing unit 103 advantageously implementing a conventional corner-based detector. This is possible due to an indentation in the lower part of the valley, which indeed can be detected as a “corner”. On the right-hand side of the sixth point 10f, a seventh 10g and an eight point 10h are randomly sampled from a greater set of edge-detected contour points.

Hence, the optional embodiment of combining random sampling of edge-detected contour points with corner-based detection is particularly advantageous in that the corner detection exploits small-scale features when available, while the edge detection conversely turns to stable medium-scale features, i.e. valleys or ridges, in the absence of small-scale features.

Further in FIG. 5b, for illustrative purpose only, are two dashed lines 20, 30 respectively indicating a set of available interest points associated with a single valley. From this set, a subset of contour points is drawn: 10a, 10dat a lower edge of the valley and the contour points 10b, 10c, 10e, 10g, 10h at an upper edge of the valley in question. Finally, a single corner point is shown in 10f.

However, due to general lack of clear and distinct features in a fingerprint image, the two lines 20, 30 defining the detected fingerprint valley are highly irregularly shaped from one captured image to another, and typically suffer from noise which in practice breaks the respective valley-defining line 20, 30 up into segments. This makes it practically difficult to recreate the same fingerprint over a plurality of fingerprints which ultimately results in a non-robust fingerprint matching process.

In the invention, after these seven contour points and one corner point 10a-10h have been detected in the sub-section of the captured image as illustrated in FIG. 5b, each detected point 10a-10h is in step S103 projected onto the medial axis 40 of the valley, resulting in a corresponding number of so called candidate interest points 11a-11h incident with the medial axis 40.

The medial axis of an object is the set of all points having more than one closest point on the object's boundary.

Thus, in lack of stable corners, it is proposed to fixate interest points in one dimension by way of the medial axes of fingerprint valleys or ridges, i.e. a set of points having more than one nearest valley/ridge contour point.

Hence, the invention proposes two approaches for arriving at a point on the medial axis:
1) use a conventional corner-based interest point detector and project the detected points onto the medial axis, and/or
2) detect edge points and project a subset of these points onto the medial axis.

As the corner-based projected points from 1) may be scant, the corner-based projected points may be augmented with the edge-based projected points from 2), which augmented points together enable the final ridge/valley point characterization.

Alternatively, option 1) may be left out entirely as is illustrated in FIG. 4; either for providing a simpler approach, or due to the observation that the quality of these points is not good enough.

FIG. 5c illustrates the embodiment of the invention where both contour points 10a-10e, 10g-10h and a corner point 10f are detected and projected onto the medial axis 40.

Hence, in a first step S101, the fingerprint sensor 102 captures at least one image of a fingerprint of a finger contacting the fingerprint sensor 102.

Thereafter, in step S102, the processing unit 103 detects contour points 10a-10e, 10g-10h of at least one ridge or valley of the fingerprint in the captured image.

Further, in step S102a the processing unit 103 detects corner points 10f of at least one ridge or valley of the fingerprint in the captured image.

In step S102, the contour points 10a-10e, 10g-10h are projected onto the medial axis 40 resulting in candidate interest points 11a-11e, 11g-11h, while in step S102a the corner point 10f is projected onto the medial axis 40 resulting in candidate interest point 11f.

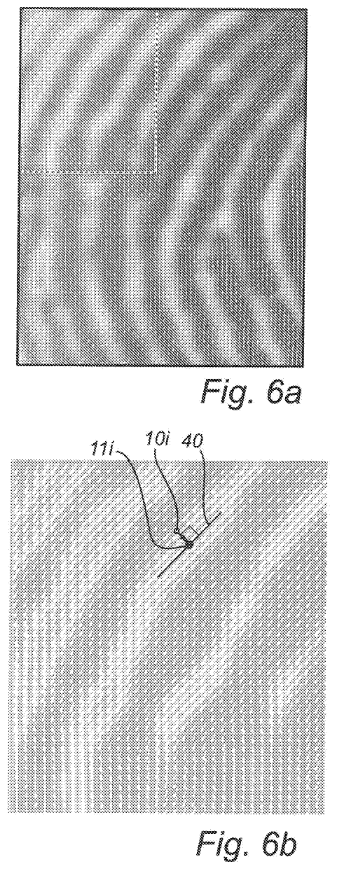

FIGS. 6a and 6b illustrate the projection of a contour or corner point of a valley/ridge onto the medial axis of said valley/ridge by way of an estimate of the local image orientation, where FIG. 6a illustrates a captured image of a fingerprint, while FIG. 6b illustrates an indicated sub-section of the captured image in FIG. 6a. Both with the local image orientation estimate illustrated as a superimposed vector field.

Hence, a detected contour point 10i, i.e. in this example stemming from an edge detection, is orthogonally projected onto the medial axis 40 of the valley/ridge, thereby creating a corresponding candidate interest point 11i.

With the projection of the contour points and corner point 10a-10h onto the medial axis 40 of the fingerprint valley in the captured image, thereby creating the more stable candidate interest points 11a-11h situated on the medial axis 40, a fingerprint sensing system less susceptible to noise is advantageously attained.

This process enables subsequent forming of the valley from the candidate interest points 11a-11h, i.e. the points resulting from the plurality of contour points and the single corner point 10a-10h being projected onto the medial axis 40, whereby a far more robust method of locating a valley and/or ridge in fingerprint images advantageously is provided as compared to the prior art approach of using conventional interest point detection to extract valleys/ridges. It is noted that actual forming of ridges and/or valleys in order to ultimately identify a fingerprint in a captured image is a procedure which lies outside the scope of the invention.

This is particularly relevant in case a relatively sparse set of points are used to form valleys/ridges. In practice, a fingerprint sensing system operates with a limited number of contour points due to processing capability of the processing unit of the system, and requirements on fingerprint processing time.

This process is repeated for a plurality of ridges and/or valleys of the captured image until a sufficient number of ridges and/or valleys are located, thereby subsequently enabling identification of a fingerprint in the captured image.

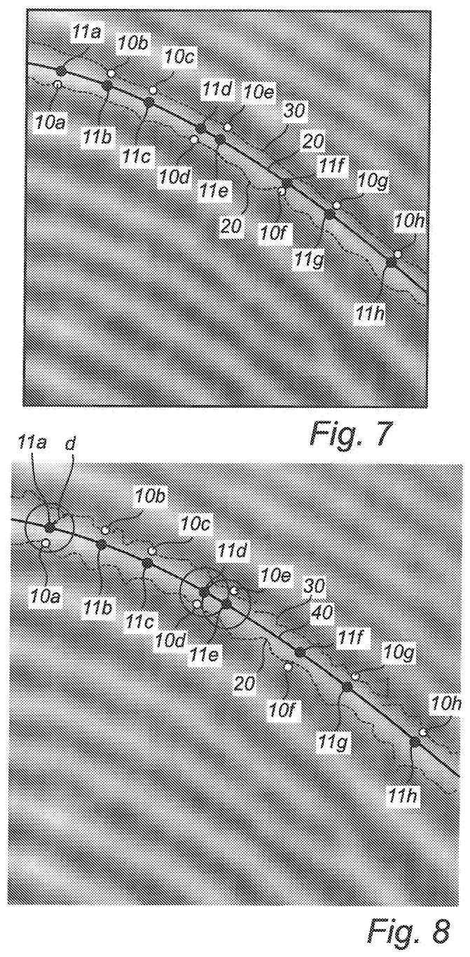

It should be noted that even in case of more or less noiseless edge contours 20, 30 illustrated with reference to FIG. 7 (being the boxed sub-section of the image shown in FIG. 5a); utilizing candidate interest points 11a-11h on the medial axis 40 remain a more compact way of describing the valley location with a sparse contour point set. In practice, the edge contours 20, 30 will however not be as noiseless and nicely shaped as those shown in FIG. 7.

FIG. 8 illustrates the sub-section of the captured fingerprint previously discussed with reference to FIG. 5b, but where a further feature according to an embodiment is shown.

In this embodiment, a proximity criterion must be satisfied for a candidate interest point 11a-11d to be included in the set of candidate interest points along the medial axis 40 enabling forming of a ridge/valley.

With reference to FIG. 8, the proximity criterion is illustrated by means of a circle 50 having a radius r=d.

As previously has been described, the detected first contour point 10a is projected onto the medial axis 40 to create the corresponding first candidate interest point 11a, the detected second contour point 10b is projected onto the medial axis 40 to create the corresponding second candidate interest point 11b, and so on.

In this context, it should be noted that this enumeration of points 10a-10h—and corresponding candidate interest points 11a-11h being formed by projecting the points 10a-10h onto the medial axis 40—is used for illustrative purposes only to describe the projection of points onto the medial axis of a single valley. As the sampling is performed across all corner and contour points in the image in order to form the points subjected to medial axis projection, it is very unlikely that the eight point samples 10a-10h will come out ordered along the valley.

Turning to the detected fourth and fifth contour points 10d, 10e, which are projected onto the medial axis 40 thereby creating corresponding fourth and fifth candidate interest points 11d, 11e; it can be seen that the fifth candidate interest points 11e is on the verge of not fulfilling the proximity criterion d, which stipulates that any candidate interest point must be located on a distance greater than or equal to a selected minimum distance d from a previously accepted candidate interest point along the medial axis 40 in order to be included in the set of candidate interest points 11a-11h which subsequently enables forming the ridge/valley.

Thus, the fourth candidate interest point 11d is located on a distance greater than d from the previous (accepted) third candidate interest point 11c, and is therefore accepted in the set of interest points 11a-11h along the medial axis forming the ridge/valley. Further, the fifth candidate interest point 11e is located on a distance d from the fourth (accepted) candidate interest point 11d, and is hence accepted in the set of candidate interest points 11a-11h along the medial axis which, after any appropriate post-processing steps are performed, enables forming the ridge/valley.

However, should the fifth interest point 11e have been located any closer to the fourth interest point 11d along the medial axis 40, it would not have satisfied the proximity criterion stipulating that an interest point must be located on a distance greater than or equal to a selected minimum distance d from any previously accepted interest point along the medial axis 40, and therefore would not have been included in the set of interest points positioned at the ridge/valley. In such a scenario, the ridge/valley would have interest points 11a-11d and 11f-11h associated with it, while the fifth interest point 11e would have been disregarded and thus not taken into account when characterising the ridge/valley.

Again, it is noted that in practice, the eight points 10a-10h will most likely not come out ordered along the valley, which has a consequence that the method in a real implementation most likely will not advance from the third candidate interest point 11c to the fourth candidate interest point 11d, from the fourth candidate interest point 11d to the fifth candidate interest point 11e, and so on. Rather, the evaluation of the proximity criterion is performed for a candidate interest point on a “first come, first serve”-basis.

In practice, most fingerprint sensing systems work with a point budget which limits the number of candidate interest points that can be derived for reasons of computing capability and/or a maximum allowed processing time. Advantageously, with the proximity criterion d, a degree of density control is attained.

If d is small, then for a fixed budget of N candidate interest points, a larger variation in local candidate interest point density is seen. At the other extreme, for a large d, the density variation is low, and the fingerprint sensing system may not even be able to utilize the entire budget of N points due to this (overly) strict criterion. Hence, a consideration is made when selecting an appropriate distance d.

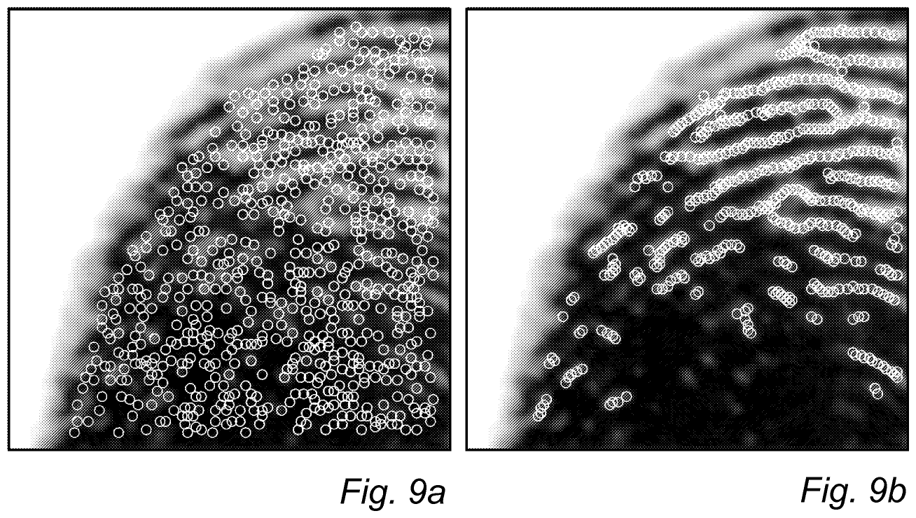

FIGS. 9a and 9b illustrate the deriving of interest points (illustrated with circles) from which a fingerprint in a captured image can be identified using conventional interest point detection (FIG. 9a) versus medial axis projection as proposed by the invention (FIG. 9b).

As can be concluded, the stringency of the detected valleys (in white) of the fingerprint is far better using the method of the invention as compared to using conventional interest point detection.

The invention has mainly been described above with reference to a few embodiments. However, as is readily appreciated by a person skilled in the art, other embodiments than the ones disclosed above are equally possible within the scope of the invention, as defined by the appended patent claims.

1. A method performed by a fingerprint sensing system of enabling identification of a fingerprint in an image captured by a fingerprint sensor of the fingerprint sensing system comprising:
capturing at least one image of a fingerprint of a finger contacting the fingerprint sensor;
detecting contour points of at least one ridge or valley of the fingerprint of the captured image; and
projecting the contour points onto the medial axis of said at least one ridge or valley, thereby enabling forming said at least one ridge or valley from the contour points projected onto the medial axis to enable identification of a fingerprint.

2. The method of claim 1, further comprising:
detecting interest points in the captured image using corner detection, which corner-detected interest points form corner points;
projecting the corner points onto the medial axis of said at least one ridge or valley, thereby enabling forming said at least one ridge or valley from the corner points projected onto the medial axis to enable identification of a fingerprint.

3. The method of claim 1, wherein the detecting of contour points comprises:
detecting interest points in the captured image using edge detection; and
randomly sampling a subset of the edge-detected interest points to form the contour points.

4. The method of claim 1, wherein a projected point is accepted in a set of projected points characterizing said at least one ridge or valley only if the projected point is located on a distance greater than a selected minimum distance (d) from a previously accepted projected contour point along the medial axis.

5. The method of claim 1, further being performed for a plurality of ridges and/or valleys of said at least one captured image to enable identification of a complete fingerprint.

6. A fingerprint sensing system comprising a fingerprint sensor and a processing unit, the fingerprint sensing system being configured to enable identification of a fingerprint in an image captured by the fingerprint sensor,
the fingerprint sensor being configured to:
capture at least one image of a fingerprint of a finger contacting the fingerprint sensor;
the processing unit being configured to:
detect contour points of at least one ridge or valley of the fingerprint of the captured image;
project the contour points onto the medial axis of said at least one ridge or valley, thereby enabling forming said at least one ridge or valley from the points projected onto the medial axis to enable identification of a fingerprint.

7. The fingerprint sensing system of claim 6, the processing unit further being configured to:
detecting interest points in the captured image using corner detection, which corner-detected interest points form corner points;
projecting the corner points onto the medial axis of said at least one ridge or valley, thereby enabling forming said at least one ridge or valley from the corner points projected onto the medial axis to enable identification of a fingerprint.

8. The fingerprint sensing system of claim 6, the processing unit being configured to, when detecting the contour points:
detect interest points in the captured image using edge detection; and
randomly sampling a subset of the edge-detected interest points to form the contour points.

9. The fingerprint sensing system of claim 6, the processing unit being configured to:
accept a projected point in a set of projected points characterizing said at least one ridge or valley only if the projected point is located on a distance greater than a selected minimum distance (d) from a previously accepted contour point along the medial axis.

10. The fingerprint sensing system of claim 6, the processing unit being configured to detect the contour or corner points for a plurality of ridges and/or valleys of the fingerprint of the captured image, and project the contour or corner points onto the respective medial axis of the plurality of ridges and/or valleys to enable identification of a complete fingerprint.

11. An electronic device comprising the fingerprint sensing system of claim 6.

12. A computer program comprising computer-executable instructions for causing the fingerprint sensing system to perform steps recited in claim 1 when the computer-executable instructions are executed on a processing unit included in the fingerprint sensing system.

13. A computer program product comprising a computer readable medium, the computer readable medium having the computer program according to claim 12 embodied thereon.
